(19) United States
(12) Patent Application Publication
(10) Pub. No.: US 2026/0162454 A1
(43) Pub. Date: Jun. 11, 2026

(54) METHODS AND SYSTEMS FOR DETECTING A SECURITY MARK IN A COLORED MEDIA DOCUMENT

(71) Applicant: XEROX CORPORATION, NORWALK, CT (US)

(72) Inventors: Ravindranath MANNURU, Guntur (IN); Haripriya CHANDRAN, Kulathur (IN); Rajasekar KANAGASABAI, Chennai (IN); Sainarayanan GOPALAKRISHNAN, Chennai (IN)

(73) Assignee: XEROX CORPORATION, NORWALK, CT (US)

(21) Appl. No.: 18/977,722

(22) Filed: Dec. 11, 2024

(51) Int. Cl. G06V 30/224; G06V 30/18

(52) U.S. Cl. CPC G06V 30/224; G06V 30/18105

(57) ABSTRACT

The present disclosure discloses methods and systems for detecting a security mark embedded in a colored media document. The method includes extracting a region of the document, wherein the region corresponds to a location of the document. Thereafter, color values associated with a color channel of the extracted region are analyzed. Based on the analysis, at least one foreground threshold value and at least one adjacent foreground threshold value are calculated. Here, the foreground threshold value and the adjacent foreground threshold value depend at least on a color of a media of the colored media document. Thereafter, the extracted region is processed using the at least one foreground threshold value to generate a foreground image. Further, the extracted portion is processed using the at least one adjacent foreground threshold value to generate an adjacent foreground image. Once generated, the foreground image and the adjacent foreground image are analyzed, and based on the analysis the security mark embedded in the colored media document is detected.

### TECHNICAL FIELD

The present disclosure relates to the field of document security. More specifically, the disclosure relates to methods and systems for detecting an infrared (IR) security mark in a colored media document.

### BACKGROUND

Individuals and organizations including government and non-government organizations deal with various confidential documents. One of the concerns associated with such documents is to protect them from malicious activity, e.g., counterfeiting, forging, unauthorized access and manipulation, etc. For this, security techniques are deployed and one technique includes the use of infrared security marks. They offer enhanced security as their manipulation is difficult.

Typically, the security marks such as, but not limited to, infrared (IR) security marks, are in the form of texts, images, signs, or the like. They are surrounded or hidden by a pattern such that the user cannot see it with the naked eye. To read such security marks, devices such as scanners, cameras, or light sources are used, and this increases the overall cost, adds dependency to the system, and so on. Further, techniques have been developed that allow regular scanners to read the infrared security marks. These techniques do not perform well when a colored media is used, for example, if a document including the security mark is printed on a colored media, say blue colored paper. Then the detection of the security mark is not accurate and may lead to incorrect detection.

What is needed is a system for detecting security marks printed on colored media.

### SUMMARY

According to aspects illustrated herein, a method for detecting a security mark such as, for example, but not limited to, an IR security mark embedded in a colored media document is disclosed. The method includes extracting a region of the colored media document, wherein the region can correspond to a pre-defined location of the colored media document. Color values associated with a color channel of the extracted region are analyzed, and based on the analysis, at least one foreground threshold value and at least one adjacent foreground threshold value are determined. The foreground threshold value and the adjacent foreground threshold value depend at least on a color of a media of the colored media document. Once determined, the extracted region is processed using the at least one foreground threshold value to generate a foreground image. The extracted region is processed using the at least one adjacent foreground threshold value to generate an adjacent foreground image. Based on analysis of the foreground image and the adjacent foreground image, the security mark embedded in the colored media document is detected.

According to further aspects illustrated herein, a device, such as, for example, but not limited to, a multi-function device for detecting a security mark, for example, but not limited to, an IR security mark, embedded in a colored media document is disclosed. The device includes a security mark detection module for extracting a region of the colored media document, wherein the region corresponds to a pre-defined location of the colored media document; analyzing color values associated with a color channel of the extracted region; determining, based on the analysis, at least one foreground threshold value and at least one adjacent foreground threshold value, wherein the foreground threshold value and the adjacent foreground threshold value depend at least on a color of a media of the colored media document; processing, using the at least one foreground threshold value, the extracted region to generate a foreground image; processing, using the at least one adjacent foreground threshold value, the extracted region to generate an adjacent foreground image; and detecting, based on analysis of the foreground image and the adjacent foreground image, the IR security mark embedded in the colored media document.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended as an example, and illustrates embodiments of devices, systems, and processes in accordance with the subject matter as claimed herein.

FIG. 1 shows an environment in which embodiments in accordance with the present disclosure can be practiced;

FIG. 2 is a block diagram illustrating components of a multi-function device, in accordance with an embodiment of the present disclosure;

FIGS. 3A–3I illustrate images created in accordance with an embodiment of the present disclosure; and

FIG. 4 illustrates a method flowchart for detecting a security mark in a colored media document, in accordance with embodiments of the present disclosure.

### DESCRIPTION

Configurations are described to illustrate the disclosed subject matter, not to limit its scope, which is defined by the claims. Those of ordinary skill in the art will recognize a number of equivalent variations of the various features provided in the description herein.

In the present disclosure, definitions of one or more terms that are used are provided. It is understood that the definitions do not limit the scope of the present disclosure.

The term “multi-function device” is a single device or a combination of multiple devices, to perform one or more functions such as, but not limited to, printing, scanning, copying, imaging, or the like. A multi-function device can include a stand-alone scanning device, such as a scanner which can scan the document. The multi-function device may include software, hardware, firmware, or a combination thereof. The multi-function device can detect one or more security marks embedded in a document, specifically, in a colored media document. The multi-function device can detect an IR security mark and can verify the genuineness/authenticity of the security mark which can indicate characteristics of the document such as, for example, but not limited to, authenticity, genuineness, and confidentiality.

The term “document” can include artifacts that include confidential information or are otherwise confidential, and can be associated with individual users, organizations, nations, or the like. Various examples of such confidential documents may be, but not limited to, checks, legal documents, bank bonds, research data documents, contract documents, prescriptions, coupons, tickets, invoices, or disclosure documents. The document may include content in the form of text, images, graphics, or a combination thereof. The document can be in physical form such as printed on paper.

The term “colored media” refers to a document having content such as text, graphics, images, and the like, printed or overlaid on a colored media. Colored media can include, but are not limited to including, media such as papers, envelopes, postcards, and currency notes, of different colors such as blue, yellow, black, and the like.

The term “security mark” refers to a mark in the document that is added, printed, and/or embedded to provide characteristics to the document, such as authenticity, genuineness, originality, and confidentiality. One such example is a security mark such as, for example, but not limited to, an IR security mark which is added to secure the document. The security mark can be in the form of texts, images, signs, or the like. The security mark can be surrounded by or hidden by a pattern such that the user cannot see it with the naked eye. The pattern can be a dot pattern and the pattern together with the security mark can be referred to as a patch or IR security patch.

The term “pre-defined location” refers to one or more pre-defined locations in the document where the security mark may be present. Pre-defined locations can include, but are not limited to including, top right corner, top left corner, bottom right corner, and bottom left corner.

The term “region” refers to a region or portion on a page of the document corresponding to the pre-defined location where the security marks are expected to be present. A region of the document is extracted by systems and methods in accordance with embodiments of the present disclosure, and processed for security mark detection. The size of the region can be same or bigger than the size of the security mark. In some configurations, a region may include additional/extra pixels, say fifty pixels, from the sides of the security mark.

The term “foreground portion” refers to one or more portions of the patch constituting the security mark, i.e., the portions constituting the embedded texts, images, signs, etc.

The term “adjacent foreground portion” refers to one or more portions of the patch that are adjacent to the foreground portions. One or more portions of the patch that are located within a predefined distance from the foreground portions are considered adjacent foreground portions. In some configurations, the portions/pixels that are located next to the foreground portions are considered adjacent foreground portions. In some configurations, the portions/pixels that are located with a predefined distance of two pixels from the foreground portions are considered to be adjacent foreground portions.

The term “foreground threshold value” refers to one or more threshold values associated with the foreground portions of the patch. In some configurations, the foreground threshold values include an upper threshold value and a lower threshold value.

The term “adjacent foreground threshold value” refers to one or more threshold values associated with the adjacent foreground portions of the patch. In some configurations, the adjacent foreground threshold values include an upper threshold value and a lower threshold value.

The term “user” includes an entity that provides the document to the device or elsewhere for processing.

The present disclosure discloses methods and systems for detecting a security mark, for example, but not limited to, an IR security mark, embedded in a document, specifically a colored media document. The methods and systems detect the security mark in the documents when the security mark is overlaid and/or printed on colored media, such as colored pages. In some configurations, a device, for example, but not limited to, a multi-function device, extracts a region of the document that may include a security mark. The device analyzes the extracted region and determines threshold values corresponding to foreground portions and adjacent foreground portions of the security mark or patch. The threshold values corresponding to foreground portions are referred to as foreground threshold values and the threshold values corresponding to adjacent foreground portions are referred to as adjacent foreground threshold values. The device processes the extracted region using the foreground threshold values and generates a foreground image. The device processes the extracted region using the adjacent foreground threshold values and generates an adjacent foreground image. The device analyzes the foreground image and the adjacent foreground image to detect and extract the security mark for further processing.

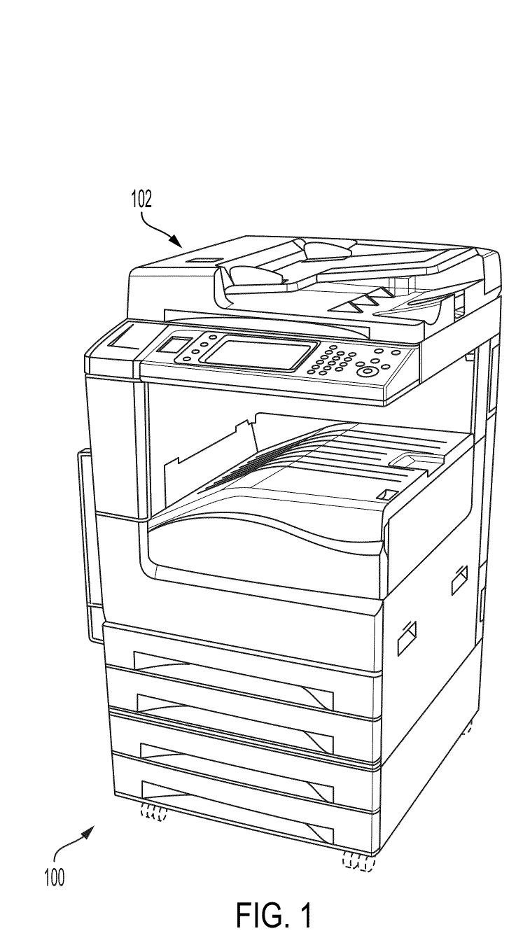

Referring now to FIG. 1, an environment 100 in which embodiments in accordance with the present disclosure can be practiced is shown. The environment 100 includes a multi-function device 102 that provides one or more functionalities such as printing, scanning, imaging, copying, and so on. The environment 100 may include scanners, printers, or any devices with scanning functionalities. The multi-function device 102 detects and extracts a security mark from a colored media document to enable verification of characteristics such as, for example, but not limited to, genuineness, authenticity, and/or confidentiality of the document.

The document can include a single-page document or a multi-page document. The document can be confidential or otherwise. Confidential documents can include, but are not limited to including, checks, legal documents, bank bonds, research data documents, contract documents, prescriptions, coupons, tickets, invoices, disclosure documents, and the like. The media of the document can be colored, e.g., blue, red, yellow, and the like. The document can include content such as texts, images, graphics, or a combination thereof. In some configurations, the document includes one or more security marks at one or more pre-defined locations in the document. Pre-defined locations can include, but are not limited to including, top right corner, top left corner, bottom right corner, and bottom left corner. The security mark may be present on one or more pages of the document. In some configurations, the document includes an IR security mark located at a pre-defined location in the document. In some configurations, the document includes multiple IR security marks that are located at different pre-defined locations in the document. In some configurations, the locations may be discovered during the process. The IR security mark can be in the form of texts, signs, images, or a combination thereof.

In some configurations, the document is provided to the multi-function device 102. In some configurations, the document is in a physical form, such as printed on paper. In some configurations, the multi-function device 102 scans the document and generates a scanned data/document, analyzes a region of the scanned data/document corresponding to the pre-defined location in the document where the IR security mark is expected to be present, extracts the region of the scanned data/document corresponding to the pre-defined location, and analyzes color values of the extracted region by performing histogram analysis on the color values. To perform the histogram analysis, the multi-function device 102 extracts color values associated with a color channel of portions/pixels of the extracted region and performs the histogram analysis on the extracted channel. In some configurations, if the color values of the extracted region are represented in International Commission on Illumination Lightness A (red, green), B (blue, yellow) (CIELAB) color space, the multi-function device 102 performs the histogram analysis on color values associated with a single color channel, for example, L-channel. Based on the analysis, the multi-function device 102 determines one or more foreground threshold values and one or more adjacent foreground threshold values. The multi-function device 102 processes the extracted region using the foreground threshold values and generates a foreground image, processes the extracted region using the adjacent foreground threshold values and generates an adjacent foreground image, combines the foreground image and the adjacent foreground image to create a new image and reconstructs the pixels of the new image, processes the reconstructed image to recognize the embedded security marks, and identifies the characteristics of the document. In some configurations, the multi-function device 102 detects and extracts the security mark embedded in the colored media.

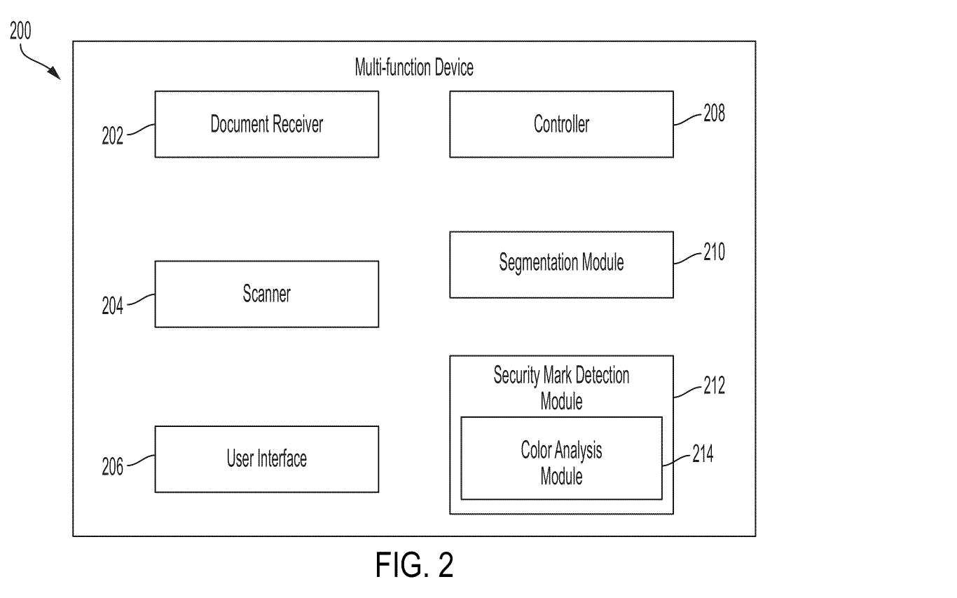

Referring now to FIG. 2, a block diagram illustrating various components of a multi-function device 200 for implementing the current disclosure is shown. As shown, the multi-function device 200 includes a document receiver 202, a scanner 204, a user interface 206, a controller 208, a memory 210, and a security mark detection module 212 including a color analysis module 214. Although, the security mark detection module 212 and the color analysis module 214 are shown as independent modules. It is understood that the modules 212 and 214 can be components of the controller 208, and the functionalities of the modules 212 and 214 can be performed by the controller 208 without departing from the scope. The components 202-214 are connected to each other via an electronic communication system. And, the components 202-214 communicate with each other for performing various functions of the present disclosure. The multi-function device 200 may further include additional component(s).

A document is submitted to the multi-function device 200 for further processing. For example, the document can include confidential content and one or more security marks. The security mark can be in the form of texts, images, signs, or a combination thereof. Further, the security mark can be surrounded or hidden by a pattern such that the security mark cannot be see with a human eye. The pattern can be a dot pattern and collectively the pattern and the security mark can be referred to as a security patch, for example, but not limited to, an IR security patch. The document can be a multi-page document and can include the security mark on one or more pages of the document. The security mark can be located at one or more pre-defined locations in the document, for example, but not limited to, top right corner, top left corner, bottom right corner, and bottom left corner. The document can be a colored media document, i.e., the media of the document is colored.

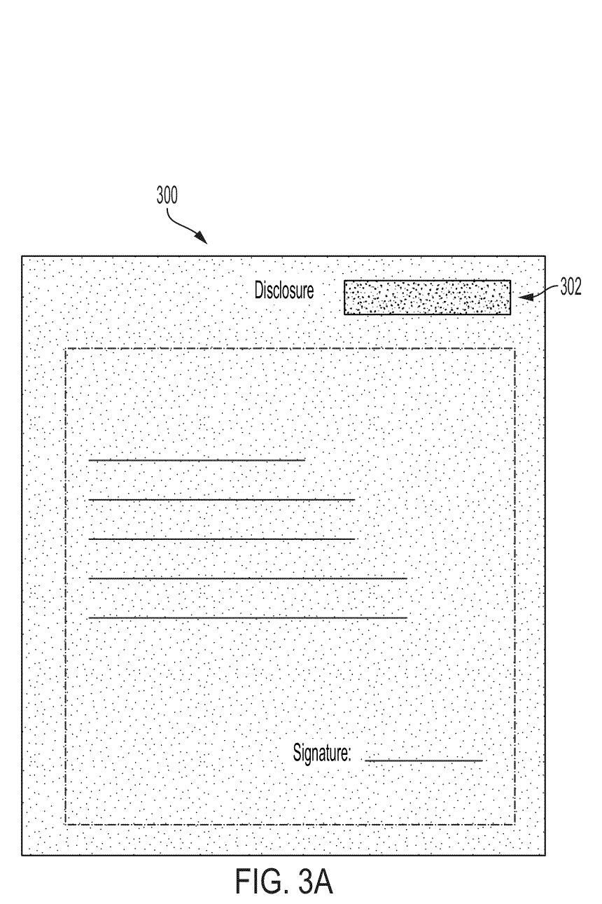

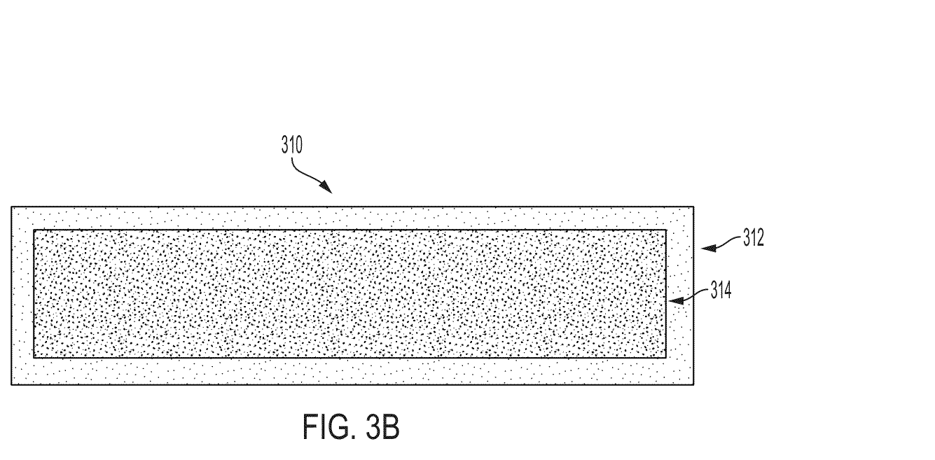

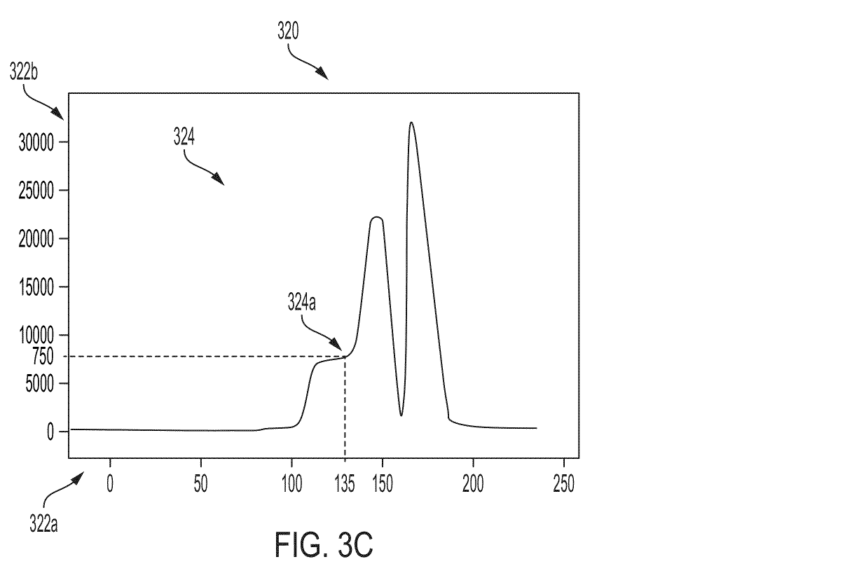

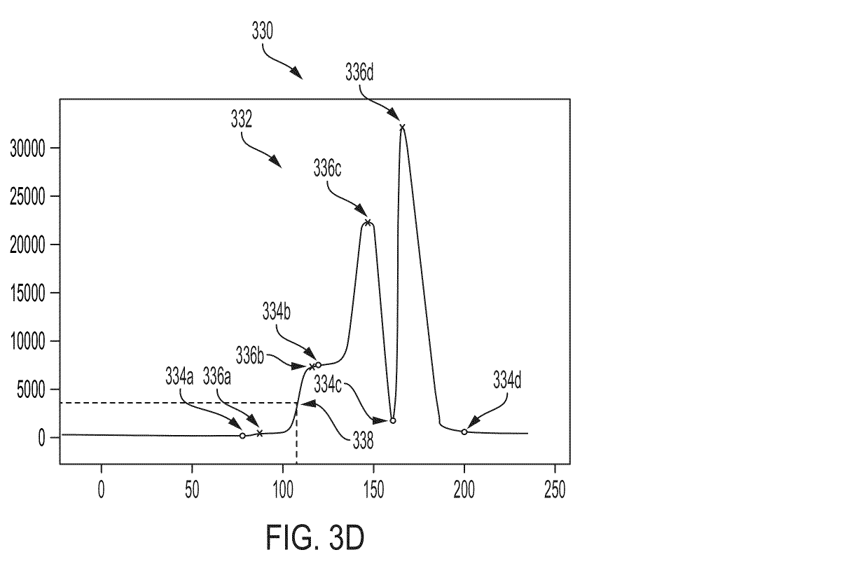

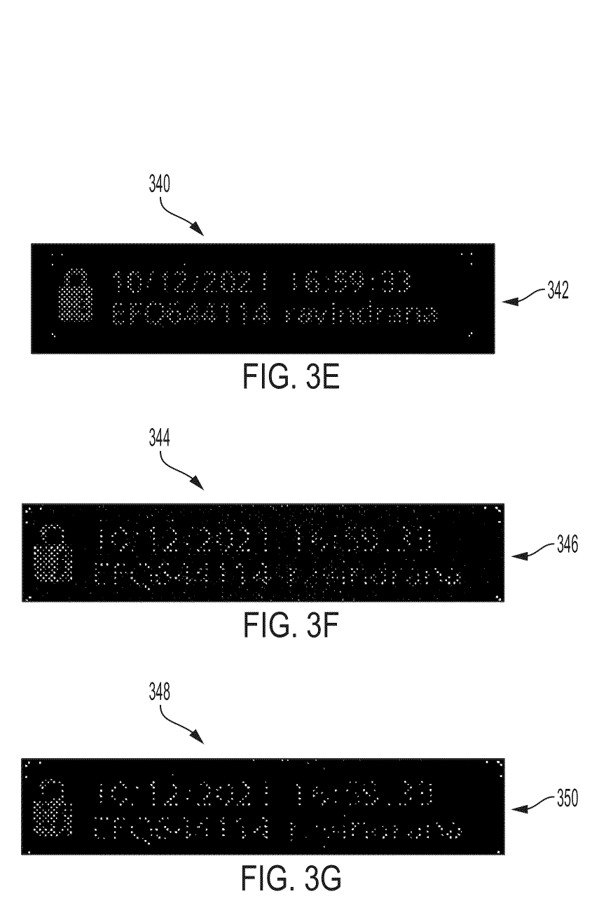

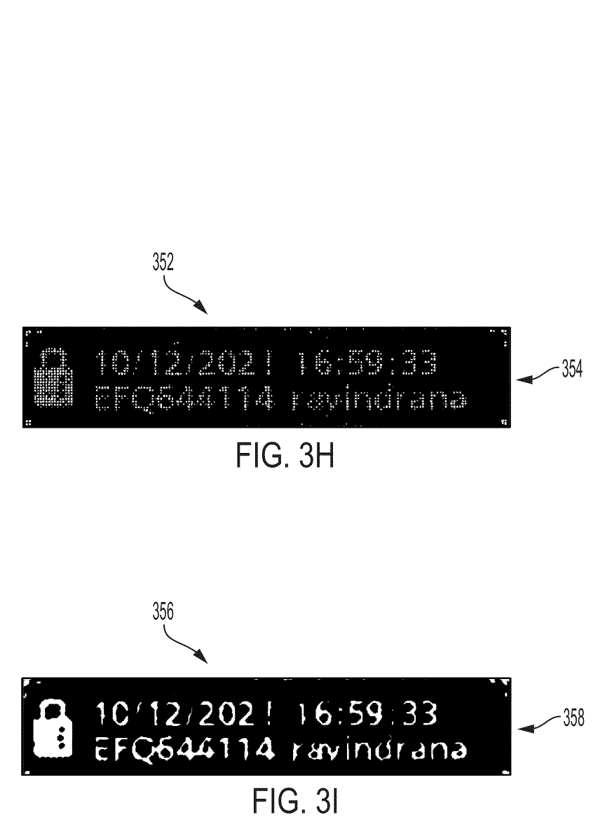

Referring now to FIG. 3A, a colored media document 300 is shown. The document 300 includes content such as text, images, etc., overlaid/printed on a blue-colored media (page). The document 300 also includes a security patch 302. The security patch 302 includes one or more security marks in the form of text, images, etc. (not visible).

Referring again to FIG. 2, the document is submitted at the multi-function device 200 when the document is placed at a document receiver 202, such as a platen or an automatic document handler (ADH). The user interface 206 displays multiple options such as scan, print, workflow, fax, and so on. In some configurations, the user interface 206 displays an option, for example, but not limited to, a security mark detection workflow option, which enables the detection of a security mark in the document. The option can be detected, or can be activated by default by the multi-function device 200, and the document is scanned. In some configurations, a user initiates scanning by selecting a scan option presented on the user interface 206, and the controller 208 triggers the scanner 204 to scan the document. The scanner 204 scans the document and generates scanned data, for example, raw scanned images in a color space/format such as, for example, but not limited to, color space format such as RGB (Red-Green-Blue) color space. The controller 208 forwards the scanned data in the RGB color space to the security mark detection module 212 which detects and recognizes the embedded security mark. The security mark detection module 212 converts the received scanned data/image from the RGB color space to a LAB color space (CIELAB color space). In the LAB color space, color values are expressed in three values, where L* is for perceptual lightness (associated with the L-channel) and a* and b* are device-independent coordinates that can be converted from or into signals for the primary colors of human vision which include red, green, and blue (RGB); or, as needed, for color spaces used in printing, e.g. cyan, magenta, yellow, and black (CMYK). The security mark detection module 212 performs a blurring operation to reduce the noise and to decrease the inter-pixel distance between foreground halftone dots. The security mark detection module 212 performs the blurring operation using a blur kernel of a suitable size. In some configurations, the security mark detection module 212 performs the blurring operation using a blur kernel of size 3*3.

The security mark detection module 212 extracts a region, possibly at a pre-defined location, of the document that may include the security mark. The security mark detection module 212 extracts the region of scanned data, possibly corresponding to the pre-defined location. In some configurations, there is one pre-defined location. In some configurations, there are multiple pre-defined locations. The security mark detection module 212 extracts the region of the scanned data corresponding to the pre-defined location or where the security mark is expected to be present. The size of the extracted region can be bigger than the size of the security mark/patch, i.e., additional pixels are extracted from the sides of the security mark/patch. For example, if the size of the security mark/patch is x*y pixels, then the security mark detection module 212 extracts a region such that the size of the extracted region is (x+100)*(y+100) pixels, i.e., an additional 50 pixels are extracted from the sides of the security mark.

Referring now to FIG. 3B, snapshot 310 shows the extracted region 312 that includes the security mark 314, and the size of the extracted region 312 is greater than the size of the security mark 314. The security mark detection module 212 (FIG. 2) analyzes the extracted region 312 to determine threshold values for the detection of the embedded security mark by analyzing the color values of pixels of the extracted region.

Referring again to FIG. 2, the security mark detection module 212 analyzes color values in the L-channel of the pixels of the extracted region. The security mark detection module 212 obtains the color values or intensity values in the L-channel of the pixels for analysis. The security mark detection module 212 forwards the obtained L-channel color values to the color analysis module 214 for further processing. The color analysis module 214 performs a histogram analysis on the L-channel color values by generating a histogram of the L-channel color values. In some configurations, while generating the histogram, the color analysis module 214 calculates the frequency of L-channel color values of different pixels in the extracted region and plots the frequency values with respect to the number of pixels.

Referring now to FIG. 3C, snapshot 320 illustrates of a histogram, where the x-axis 322a represents the color values and the y-axis 322b represents the number of pixels. The histogram plot 324 indicates a distribution of frequency of color values of the pixels. In the plot 324, the points indicate a color value and the number of pixels having the color value. For example, point 324a indicates that 7500 pixels have a color value 135.

Referring again to FIG. 2, the color analysis module 214 calculates one or more threshold color values for the foreground portion and the adjacent foreground portion. The color analysis module 214 calculates a lower threshold value and an upper threshold value for both the foreground portion and adjacent foreground portion by identifying and analyzing peaks and valleys in the histogram, and based on the analysis, calculating the different threshold values. For the foreground portion, the color analysis module 214 considers the color value corresponding to the first valley point as the lower threshold value, and the mean of the histogram as the upper threshold value. For the adjacent foreground portion, the color analysis module 214 considers a color value corresponding to a valley point that occurs at a lower color direction value than the highest peak of the histogram as the lower threshold, i.e., the valley point to the left of the highest peak in the histogram is considered as the lower threshold value. The color analysis module 214 considers a color value corresponding to a valley point at a higher color value than the highest peak of the histogram as the upper threshold, i.e., the valley point to the right of the highest peak in the histogram is considered as the upper threshold value.

Referring now to FIG. 3D, snapshot 330 illustrates a histogram plot 332 indicating a distribution of frequency of color values, specifically L-channel color values of pixels. Reference numerals 334a, 334b, 334c, and 334d indicate the valley points on the plot 332. Reference numerals 336a, 336b, 336c, and 336d indicate the peaks or peak points on the plot 332. Reference numeral 338 indicates the mean of the histogram. The color analysis module 214 (FIG. 2) identifies the valley 334a as a first valley point, peak 336d as a highest peak, valley 334c as a valley point to the left of the highest peak 336d and the valley 334d as the valley point to the right of the highest peak 336d. For the foreground portion, the color analysis module 214 (FIG. 2) considers the color value corresponding to the valley point 334a as the lower threshold value and the color value corresponding to the mean point 338 as the upper threshold value. For the adjacent foreground portion, the color analysis module 214 (FIG. 2) considers the color value corresponding to the valley point 334c as the lower threshold value and the color value corresponding to the valley point 334d as the upper threshold value corresponding to the foreground portion and the adjacent foreground portion. In some configurations, the calculated threshold values, i.e., foreground threshold values and adjacent foreground threshold values, depend upon various factors, such as color of the foreground portion, color of the adjacent foreground portion, color of the media of the document, and the like.

Referring again to FIG. 2, the security mark detection module 212, analyzes the extracted region/portion using the foreground threshold values to identify the foreground pixels or the pixels constituting the security mark. The security mark detection module 212 compares the color values in the L-channel of the pixels of the extracted region with the foreground threshold values, i.e., the upper and the lower threshold values. Based on the comparison, the security mark detection module 212 sets the values of the pixels of the extracted region as ‘0’ or ‘255’. In some configurations, if the L-channel color values of the pixels lie between the upper and lower threshold values, the security mark detection module 212 sets the value of the pixel as ‘255’, else as ‘0’. In one example, if the L-channel color value for a pixel is L1, and calculated upper threshold value is L_upper and the lower threshold value is L_lower. If the value of L1 is greater than L_lower and smaller than L_upper, the security mark detection module 212 sets the value of the pixel as ‘255’, else sets the value of the pixel as ‘0’. The security mark detection module 212 generates a first binary image, which is referred as a foreground image. In the foreground image, the white pixels, i.e., pixels with value ‘255’, correspond to the pixels for which the color value lies within the calculated foreground threshold values and the remaining pixels are black pixels, i.e., the value is set as ‘0’. The security mark detection module 212 identifies the white pixels, i.e., pixels with value ‘255’, as foreground pixels. The security mark detection module 212 analyzes the extracted region using the foreground threshold values, generates the foreground image and identifies the foreground pixels, i.e., pixels constituting the security mark or white pixels. Snapshot 340 (FIG. 3E) of a foreground image 342 (FIG. 3E) is illustrated. When the security mark detection module 212 analyzes the extracted patch 312 (FIG. 3B) using the foreground threshold values, the foreground image 342 is generated.

Continuing to refer to FIG. 2, the security mark detection module 212 analyzes the extracted/localized patch using the adjacent foreground threshold values by analyzing the pixels that are adjacent to the foreground pixels in the extracted patch. The security mark detection module 212 identifies the pixels adjacent to the foreground pixels using the foreground image, and identifies the foreground pixels in the extracted patch, i.e., pixels of the extracted patch corresponding to the white pixels in the foreground image. The security mark detection module 212 identifies the pixels that are adjacent to the foreground pixels in the extracted patch by considering the pixels as adjacent to the foreground pixels if the pixels are located next to the foreground pixels in the extracted patch. In some configurations, the security mark detection module 212 considers the pixels as adjacent pixels that are located at a distance of 2 pixels or less than 2 pixels from the foreground pixels in the extracted patch. When the adjacent pixels, i.e., pixels adjacent to the foreground pixels in the extracted patch, are identified, the security mark detection module 212, sets the value of the remaining pixels of the extracted patch as ‘0’.

Continuing to refer to FIG. 2, the security mark detection module 212 analyzes the identified adjacent pixels, i.e., pixels adjacent to the foreground pixels, in the extracted patch by comparing the L-channel color values of the identified adjacent pixels with the adjacent foreground threshold values. Based on the comparison, the security mark detection module 212 sets the value of the identified adjacent pixels as ‘0’ or ‘255’. For example, if the L-channel color values of the adjacent pixels lie within the calculated adjacent foreground threshold values, the security mark detection module 212 sets the value of the pixel as ‘255’, else as ‘0’. The security mark detection module 212 generates a binary image which is referred as an adjacent foreground image. In the adjacent foreground image, the white pixels, i.e., pixels with value ‘255’, correspond to the pixels which are adjacent to the foreground pixels and for which the color value satisfies the threshold criteria, i.e., the color value lies within the calculated adjacent foreground threshold values, and the remaining pixels are black, i.e., the value is set as ‘0’. The security mark detection module 212 analyzes the extracted patch using calculated adjacent foreground threshold values and generates the adjacent foreground image. FIG. 3F illustrates snapshot 344 (FIG. 3F) of an adjacent foreground image 346 (FIG. 3F).

Continuing to refer to FIG. 2, the security mark detection module 212 removes noise from the adjacent foreground image. In some configurations, the security mark detection module 212 uses a median filtering technique to remove the unwanted noise from the obtained adjacent foreground image. The security mark detection module 212 generates a filtered adjacent foreground image 350 (FIG. 3G) of the image 348 (FIG. 3G). The security mark detection module 212 combines the foreground image and the filtered adjacent foreground image 350 (FIG. 3G) to create a new image. In some configurations, the security mark detection module 212 combines the foreground image 342 (FIG. 3E) and the filtered adjacent foreground image 346 (FIG. 3F) using the binary OR operation as shown by snapshot 352 (FIG. 3H) of a combined image 354 (FIG. 3H). The security mark detection module 212 reconstructs the pixels, specifically the white pixels of an image to enhance the security mark portions and recognize the security mark. The security mark detection module 212 may use pixel a shifting operation to reconstruct the pixels to create snapshot 356 (FIG. 3I) of an image 358 (FIG. 3I). The security mark detection module 212 recognizes the security mark and compares the recognized security mark with one or more pre-stored reference security marks to verify characteristics such as, for example, but not limited to, authenticity and/or genuineness of the security mark that are associated with the characteristics of the document.

Continuing to refer to FIG. 2, the user interface 206 can be an external display or device that can be connected to the multi-function device 200, and can display various options to receive user input, for example, but not limited to, scan, print, and color information. In some configurations, the user interface 206 displays the result of the identification of the characteristics of the document. The memory 210 stores, for example, but not limited to, the threshold values including foreground threshold values and the adjacent foreground threshold values. The memory 210 maintains a repository of security marks, for example, but not limited to, pre-stored IR security marks, that can be retrieved by the security mark detection module 212.

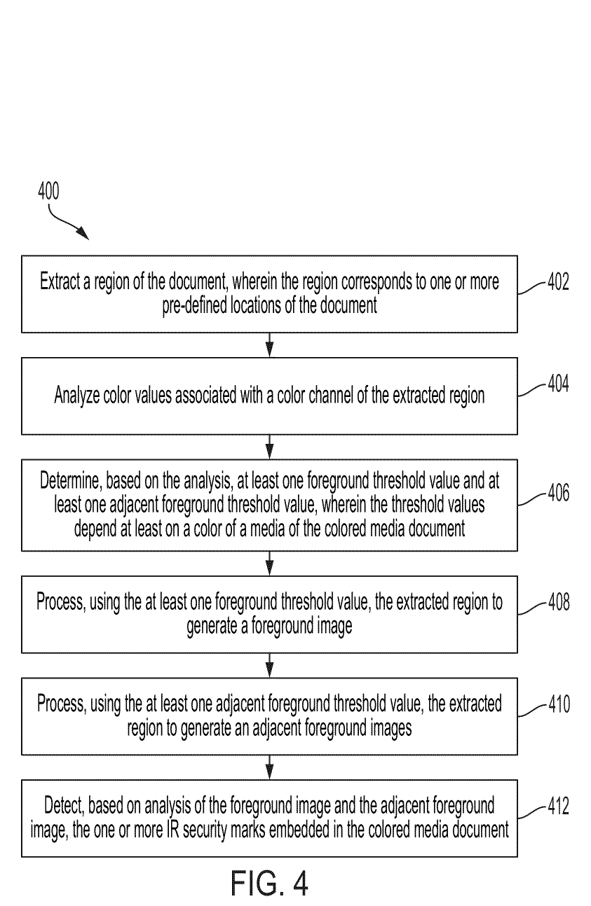

Referring now to FIG. 4, method 400 for detecting security marks from a colored media document is shown. In some configurations, the method 400 may be implemented at a multi-function device, such as, for example, but not limited to, the multi-function device 102 (FIG. 1) or the multi-function device 200 (FIG. 2), or a device with functionalities such as scanning, and so on. The purpose of method 400 is to verify the authenticity/genuineness of a document by determining characteristics of the document. For example, the document can include confidential content and one or more security marks. In some configurations, the security mark can be in the form of text, images, signs, or a combination thereof. The security mark is surrounded or hidden by a pattern that hides the security mark from a human eye. The pattern can be a dot pattern, solid color pattern, or the like, and collectively the pattern and the security mark may be referred to as a patch or IR patch. The confidential document can be a multi-page document and can include the security mark on one or more pages of the confidential document. The document can be a colored media document, i.e., the media of the document is colored. The security marks can be located at one or more pre-defined locations in the document. In some configurations, the pre-defined locations can include, but are not limited to including, top right corner, top left corner, bottom right corner, and bottom left corner.

In some configurations, the user submits the document and chooses from possible displayed options such as scan, print, workflow, fax, and so on. In some configurations, an option to detect a security mark can be presented that enables the detection of security marks in the document. The option can be selected, or can be enabled by default. Scanning of the document is initiated, the document is scanned, and the scanned data are provided in a color space/format which can include an Red-Green-Blue (RGB) color space. The scanned data in RGB color space can be converted to a LAB color space (CIELAB color space), and a blurring operation is performed to reduce the noise and to decrease the inter-pixel distance between foreground halftone dots. A region of the document or scanned data is extracted 402. The region corresponds to one or more locations of the document where the security mark can be present. The security mark can be present at a location, more than one location, or one or more pre-defined locations. The size of the extracted region can be bigger than the size of the security mark, i.e., additional pixels are extracted from the sides of the security mark. Color values associated with a color channel such as, but not limited to, an L-channel, for the extracted region are analyzed 404. Histogram analysis is performed on the obtained channel color values. In some configurations, a histogram of the L-channel color values is generated.

One or more threshold color values for the foreground portion and the adjacent foreground portion are generated 406 based on the histogram analysis. A lower threshold value and an upper threshold value are calculated for both the foreground portion and the adjacent foreground portion by identifying and analyzing the peaks and valleys of the histogram, and threshold values are calculated. In some configurations, for the foreground portion, a color value corresponding to the first valley point is considered as the lower threshold value, and the mean of the histogram is considered as the upper threshold value. For the adjacent foreground portion, a color value corresponding to a valley point just before the highest peak of the histogram is considered as the lower threshold, i.e., the valley point to the left of the highest peak in the histogram is considered as the lower threshold value. A color value corresponding to a valley point just after the highest peak of the histogram is considered as the upper threshold, i.e., the valley point to the right of the highest peak in the histogram is considered as the upper threshold value. The threshold values, i.e., upper and lower threshold values corresponding to the foreground portion and the adjacent foreground portion, are calculated. The calculated threshold values, i.e., foreground threshold values and adjacent foreground threshold values, depend upon various factors, such as color of the foreground portion, color of the adjacent foreground portion, color of the media of the document, and the like.

The extracted region/portion is processed 408 using the foreground threshold values to identify the foreground pixels or the pixels constituting the security mark. The color values in the L-channel of the pixels of the extracted region are compared with the foreground threshold values, i.e., the upper and the lower threshold values. Based on the comparison, the values of the pixels of the extracted region are set as ‘0’ or ‘255’. For example, if the L-channel color values of the pixels lie between the upper and lower threshold values, the value of the pixel is set as ‘255’, else as ‘0’. A first binary image is generated which is referred as a foreground image. In the foreground image, the white pixels, i.e., pixels with value ‘255’, correspond to the pixels for which the color value lies within the calculated foreground threshold values and the remaining pixels are black pixels, i.e., the value is set as ‘0’. The white pixels are identified, i.e., pixels with value ‘255’, as foreground pixels. The extracted region is analyzed using the foreground threshold values, the foreground image is generated and the foreground pixels, i.e., pixels constituting the security mark or white pixels, are identified.

The extracted/localized patch is analyzed 410 using the adjacent foreground threshold values. The pixels that are adjacent to the foreground pixels in the extracted patch are analyzed. The pixels adjacent to the foreground pixels are identified using the foreground image, and the foreground pixels in the extracted patch are identified, i.e., pixels of the extracted patch corresponding to the white pixels in the foreground image. The pixels that are adjacent to the foreground pixels in the extracted patch are identified. When the pixels adjacent to the foreground pixels in the extracted patch are identified, the value of the remaining pixels of the extracted patch is set as ‘0’. The identified adjacent pixels, i.e., pixels adjacent to the foreground pixels, in the extracted patch are analyzed. The L-channel color values of the identified adjacent pixels are compared with the adjacent foreground threshold values. Based on the comparison, the value of the identified adjacent pixels is set as ‘0’ or ‘255’. For example, if the L-channel color values of the adjacent pixels lie within the calculated adjacent foreground threshold values, the value of the pixel is set as ‘255’, else as ‘0’. A binary image is generated which is referred to as an adjacent foreground image. In the adjacent foreground image, the white pixels, i.e., pixels with value ‘255’, correspond to the pixels which are adjacent to the foreground pixels and for which the color value satisfies the threshold criteria, i.e., the color value lies within the calculated adjacent foreground threshold values, and the remaining pixels are black, i.e., the value is set as ‘0’. The extracted patch is processed using calculated adjacent foreground threshold values and the adjacent foreground image is generated. Noise is removed from the adjacent foreground image, and a filtered adjacent foreground image is generated.

The foreground image and the filtered adjacent foreground image are analyzed, and, based on the analysis, the security mark embedded in the colored media document is detected 412. The foreground image and the filtered adjacent foreground image are combined to create a new image. In some configurations, the foreground image and the filtered adjacent foreground image are combined using the binary OR operation. The pixels, specifically the white pixels of the new image, are reconstructed to enhance the security mark portions and to recognize the security mark. In some configurations, the reconstruction can be performed using a pixel shifting operation. When the security mark is recognized, and the recognized security mark is compared with one or more reference security marks to verify the characteristics such as, for example, but not limited to, authenticity and genuineness, of the security mark and the confidential document.

The present disclosure describes methods and systems for detecting and extracting an embedded security mark from a colored media document. According to the disclosure, one or more locations of the document are processed to detect and extract the security mark. The regions of the one or more locations are extracted and processed based on threshold values. The threshold values are calculated based on analysis of the extracted region or a pre-defined region, enabling the detection and extraction of the security mark from the colored media document. The methods and systems provide a solution that allows detection of the security mark from different types of media documents, and allows scanners/multi-function devices to read security marks.

The disclosure is explained with respect to a scenario where L-channel color values of pixels of the extracted portion are processed to determine/calculate the threshold values. The other color channels such as a-channel or b-channel color values can also be used to calculate the threshold values. For example, in case of the a-channel, first the a-channel color values are processed/analyzed to determine the threshold values. Thereafter, a-channel color values of the extracted patch are compared with the threshold values to detect the security mark. Similarly, the b-channel color values can also be used.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Unless specifically stated otherwise, as apparent from the discussion herein, it is appreciated that throughout the description, discussions utilizing terms such as receiving, scanning, identifying, extracting, adding, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for detecting a security mark embedded in a colored media document, the method comprising:
extracting a region of the colored media document, wherein the region comprises a location of the colored media document;
analyzing color values associated with a color channel of the extracted region;
determining, based on the analysis, at least one foreground threshold value and at least one adjacent foreground threshold value, wherein the foreground threshold value and the adjacent foreground threshold value depend at least on a color of a media of the colored media document;
processing, using the at least one foreground threshold value, the extracted region to generate a foreground image;
processing, using the at least one adjacent foreground threshold value, the extracted region to generate an adjacent foreground image; and
detecting, based on analysis of the foreground image and the adjacent foreground image, the security mark embedded in the colored media document.

2. The method of claim 1, wherein the color values comprise:
a CIELAB color space, and the color channel is at least one of L-channel, a-channel, or b-channel.

3. The method of claim 1, wherein analyzing the color values comprises analyzing a histogram of the color values associated with the color channel to identify a mean of the histogram, one or more peaks of the histogram and one or more valleys of the histogram.

4. The method of claim 3, wherein the at least one foreground threshold value is identified using the one or more valleys of the histogram or the mean of the histogram.

5. The method of claim 3, wherein the at least one adjacent foreground threshold value is identified using the one or more valleys of the histogram and the one or more peaks of the histogram.

6. The method of claim 3, wherein the color value corresponding to a first valley of the one or more valleys is identified as a lower threshold value for a foreground portion.

7. The method of claim 6, wherein the color value corresponding to the mean of the histogram is identified as an upper threshold value for the foreground portion.

8. The method of claim 6, wherein the color value corresponding to a second valley of the one or more valleys located in a direction of a lower color value than a highest peak of the one or more peaks is identified as a lower threshold value for an adjacent foreground portion adjacent to the foreground portion.

9. The method of claim 8, wherein the color value corresponding to a third valley located in the direction of a higher color value than a highest peak of the one or more peaks is identified as an upper threshold value for the adjacent foreground portion.

10. The method of claim 1, wherein processing, using the at least one foreground threshold value, comprises:
comparing the color values associated with the color channel of the extracted region with the at least one foreground threshold value to generate the foreground image.

11. The method of claim 6, wherein processing, using the at least one adjacent foreground threshold value comprises:
identifying, using the foreground image, one or more portions adjacent to one or more of the foreground portions in the extracted region; and
comparing the color values associated with the color channel of the identified one or more portions adjacent to the one or more foreground portions in the extracted region with the adjacent foreground threshold value to generate the adjacent foreground image.

12. The method of claim 1, further comprising:
combining the foreground image and the adjacent foreground image to create a created image;
extracting the security mark from the created image; and
verifying an authenticity of the colored media document by matching the extracted security mark with one or more pre-selected security marks.

13. A multi-function device for detecting a security mark embedded in a colored media document, the multi-function device executing instructions to perform operations comprising:
extracting a region of the colored media document, wherein the region comprises a location of the colored media document;
analyzing color values associated with a color channel of the extracted region;
determining, based on the analysis, at least one foreground threshold value and at least one adjacent foreground threshold value, wherein the foreground threshold value and the adjacent foreground threshold value depend at least on a color of a media of the colored media document;
processing, using the at least one foreground threshold value, the extracted region to generate a foreground image;
processing, using the at least one adjacent foreground threshold value, the extracted region to generate an adjacent foreground image; and
detecting, based on analysis of the foreground image and the adjacent foreground image, the security mark embedded in the colored media document.

14. The multi-function device of claim 13, where the operations further comprise:
selecting the color channel from a CIELAB color space including L-channel, a-channel, and b-channel; and
obtaining the color values associated with the selected color channel.

15. The multi-function device of claim 13, wherein analyzing the color values comprises:
identifying a mean of a histogram of the color values associated with the color channel, one or more peaks of the histogram and one or more valleys of the histogram.

16. The multi-function device of claim 15, wherein the at least one foreground threshold value is identified using the one or more valleys of the histogram or the mean of the histogram.

17. The multi-function device of claim 15, wherein the at least one adjacent foreground threshold value is identified using the one or more valleys of the histogram and the peaks of the histogram.

18. The multi-function device of claim 13, wherein processing, using the at least one foreground threshold value, comprises:
comparing the color values associated with the color channel of the extracted region with the at least one foreground threshold value to generate the foreground image.

19. The multi-function device of claim 13, wherein processing, using the at least one adjacent foreground threshold value, comprises:
identifying, using the foreground image, one or more portions adjacent to one or more foreground portions in the extracted region; and
comparing the color values associated with the color channel of the identified one or more portions adjacent to the one or more foreground portions in the extracted region with the adjacent foreground threshold value to generate the adjacent foreground image.

20. The multi-function device of claim 13, wherein the operations further comprise:
combining the foreground image and the adjacent foreground image to create a created image;
extracting the security mark from the created image; and
verifying an authenticity of the colored media document by matching the extracted security mark with one or more pre-selected security marks.
